(19) United States
(12) Patent Application Publication
(10) Pub. No.: US 2005/0237025 A1
(43) Pub. Date: Oct. 27, 2005

(54) Charger for a rechargeable battery

(76) Inventor: Alexander Osswald, Stuttgart (DE)

Correspondence Address: MICHAEL J. STRIKER, 103 EAST NECK ROAD, HUNTINGTON, NY, 11743, US

(21) Appl. No.: 11/108,953

(22) Filed: Apr. 19, 2005

(30) Foreign Application Priority Data
Apr. 24, 2004 (DE) 10 2004 020176.5

(51) Int. Cl. H02J 7/00

(52) U.S. Cl. 320/128

(57) ABSTRACT

A charger for a rechargeable battery (4) has one circuit (5), connectable to a supply voltage (V) and furnishing the charging current for the battery, and one circuit (6), connected in a parallel circuit to the first circuit and required for regulating the charging current. In the parallel circuit a switch (7) is provided, which interrupts the parallel circuit if the circuit (5) that furnishes the charging current is disconnected from the supply voltage (V). This prevents a leakage current from flowing out of the battery (4) via the parallel circuit and thereby discharging the battery (4) when the charger (1) is switched off from the supply voltage (V).

### BACKGROUND OF THE INVENTION

The present invention relates to a charger for a rechargeable battery, in which the charger has one circuit, connectable to a supply voltage and furnishing the charging current for the battery, and one circuit, connected in a parallel circuit to the first circuit and required for regulating the charging current and/or regulating the charging voltage. Chargers with a regulatable charging current are constructed in this way, as taught for instance by German Patent Disclosure DE 101 49 978 A1.

If the battery is connected to a charger while the charger is no longer connected to the supply voltage (line voltage), the battery can become deeply discharged by leakage currents that flow back into the charger. Batteries that are not protected against deep discharge (such lithium ion batteries) can be damaged by such leakage currents. The source of unwanted leakage currents are circuits that are parallel to the circuit that furnishes the charging current for the battery.

### SUMMARY OF THE INVENTION

The object of the invention is to disclose a charger of the type defined at the outset which prevents a discharge of a battery connected to it when the supply voltage is switched off.

This object is attained with the characteristics of claim 1, in that a switch is provided, in the parallel circuit to the circuit that furnishes the charging current for the battery, that interrupts the parallel circuit if the current source is disconnected from the supply voltage. The switch that carries the flow of a leakage current that leads to the discharge of the battery connected to the charger is advantageously located in the parallel circuit, rather than in the charging current circuit. In the charging current circuit, such a switch would cause losses in the charging process of the charger.

An advantageous refinement of the invention is disclosed in the dependent claim. In it, the switch is an electrically controllable switch, which receives a control signal from the circuit carrying the charging current, and the status of the control signal depends on whether the circuit is connected to the supply voltage or is disconnected from it.

The invention is described in further detail below in terms of two exemplary embodiments shown in the drawings.

### BRIEF DESCRIPTION OF THE DRAWINGS

FIG. 1 is a block circuit diagram of a charger with a circuit in the parallel circuit, on the side of the positive pole; and

FIG. 2 is a block circuit diagram of a charger with a circuit in the parallel circuit, on the side of the negative pole.

### DETAILED DESCRIPTION OF THE PREFERRED EMBODIMENTS

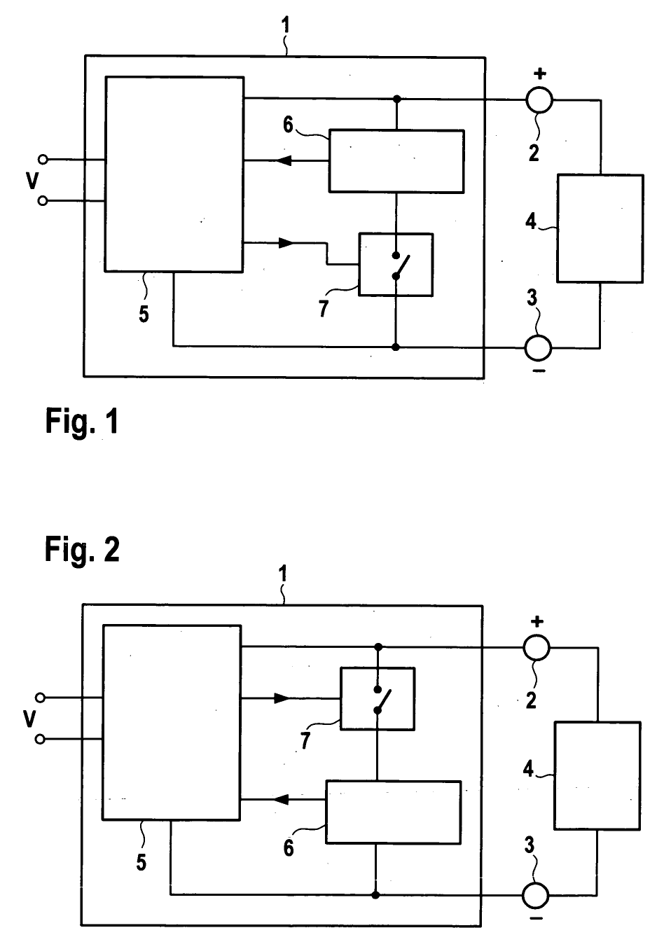

FIG. 1 shows a block circuit diagram of a charger 1, to both of the outputs of which, that is, the positive pole 2 and the negative pole 3, a rechargeable battery 4 is connected. The rechargeable battery 4 may be a single battery cell, or a battery pack made up of a plurality of battery cells. The charger 1 substantially comprises a circuit 5, which furnishes the charging current for the battery 4. This circuit 5, which is embodied for instance as a current source circuit, receives its energy from a supply voltage V (for instance, line voltage). In a parallel circuit to this circuit 5 that furnishes the charging current for the battery, there is a circuit 6, which has a function for regulating the charging current. This circuit 5 for instance detects the charging current flowing into the battery 4 and/or the charging voltage applied to the terminals 2 and 3 and carries this measured variable as a controlled variable to the circuit 5, which regulates the charging current or the charging voltage to a defined reference value as a function of the measured variable.

If the charger 1 is switched off from the supply voltage V and the battery 4 is still connected to the output terminals 2 and 3 of the charger 1, a leakage current can flow out of the battery via the parallel circuit (circuit 6), and as a consequence the battery 4 may become damaged. To suppress this disadvantageous leakage current, a circuit 7 is incorporated into the parallel circuit and is opened whenever the circuit 5 that generates the charging current is disconnected from the supply voltage V. This switch 7 is preferably an electrically controllable switch, such as a relay or a transistor. From the circuit 5 that furnishes the charging current, the electrically controllable switch 7 receives a control signal, the status of which depends on whether the circuit 5 is connected to the supply voltage V or is disconnected from it.

In the exemplary embodiment in FIG. 1, the switch 7 is located between the negative pole 3 of the charger 1 and the circuit 6. However, as the exemplary embodiment of FIG. 2 shows, the switch 7 may also be inserted between the positive pole 2 of the charger 1 and the circuit 6.

1. A charger for a rechargeable battery (4), in which the charger (1) has one circuit (5), connectable to a supply voltage (V) and furnishing the charging current for the battery, and one circuit (6), connected in a parallel circuit to the first circuit and required for regulating the charging current and/or regulating the charging voltage, wherein in the parallel circuit a switch (7) is provided, which interrupts the parallel circuit if the circuit (5) that furnishes the charging current is disconnected from the supply voltage (V).

2. The charger as recited in claim 1, wherein the switch (7) is an electrically controllable switch, which receives a control signal from the circuit (5) carrying the charging current, and the status of the control signal depends on whether the circuit (5) is connected to the supply voltage (V) or is disconnected from it.
